(19) United States
(12) Patent Application Publication
(10) Pub. No.: US 2012/0054165 A1
(43) Pub. Date: Mar. 1, 2012

(54) Electronic Medical Record Mobile Access Package

(76) Inventor: Stephen D. Brown, Houston, TX (US)

(21) Appl. No.: 13/219,990

(22) Filed: Aug. 29, 2011

Related U.S. Application Data
(60) Provisional application No. 61/377,626, filed on Aug. 27, 2010.

(51) Int. Cl. G06F 17/30

(52) U.S. Cl. 707/705; 707/E17.008

(57) ABSTRACT

A method of accessing information stored on a records server database is provided, the method comprising receiving a request for information from a server-sided application; transmitting the information from the records server database to the server-sided application; converting the information into data readable on a mobile device; and transmitting the data to said mobile device using a client-sided application. Systems, subsystems, structures and means suitable for carrying out the method are also disclosed.

### CROSS-REFERENCE TO RELATED APPLICATIONS

The present application claims the benefit of prior U.S. Provisional Application No. 61/377,626, filed Aug. 27, 2010.

### FIELD OF THE INVENTION

The present invention relates generally to methods and means for interfacing with electronic medical record software packages, and in a particular though non-limiting embodiment, to a portable means and associated method for accessing electronic medical records over a variety of mobile personal data devices.

### BACKGROUND OF THE INVENTION

Electronic Medical Record (“EMR”) software packages are becoming more prevalent within the medical community. Many of these software packages are fully integrated into a physician's practice, allowing electronic charting, scheduling, billing, and other functions.

Recent federal legislation incentivizes implementation of such packages, providing financial assistance to physicians in their installation of these electronic tools. Thus, increasing numbers of physicians and other health care providers are actively adopting such technologies.

As of yet, however, no EMR companies or vendors have developed adequate mobile implementations or interfaces for their products, even though many physicians require access to patient records while away from their offices. Whether making hospital rounds, fielding telephone calls after hours, or working from home, accessible electronic medical records are of ever greater importance.

There is, therefore, a long-felt but unmet need for a remote method and means for accessing and/or editing medical records and the like in a safe, secure and efficient manner.

### SUMMARY OF THE INVENTION

A system for accessing electronic records is provided, the system including at least: a client application installed on a personal data device; a server-sided application installed on a client network; a records server database; and an internet information services server; wherein the server-sided application is in operative communication with the records server database and the internet information services server; and the client application is in operative communication with the records server database and the internet information services server using a secure connection.

A related method of accessing information stored on a records server database is provided, including at least: receiving a request for information from a server-sided application; transmitting the information from the records server database to the server-sided application; converting the information into data readable on a mobile device; and transmitting the data to said mobile device using a client-sided application.

### BRIEF DESCRIPTION OF THE DRAWINGS

FIG. 1 is a block diagram representing a system and method of accessing information wirelessly from an EMR database.

### DETAILED DESCRIPTION OF SEVERAL EXAMPLE EMBODIMENTS

In a generalized embodiment, the presently disclosed EMR package provides a solution to deficiencies in the EMR software field. In one example embodiment, the application interfaces seamlessly with the popular e-MDs Solution Series™ EMR package, thereby allowing mobile access to virtually all aspects of the EMR software. Those of ordinary skill in the art, however, will readily appreciate that the remote access means disclosed herein will function equally well with many other record storage and delivery packages, so long as necessary interface and programming changes are effected so as to maintain system compatibility.

In one example embodiment, the application is configured to cooperatively function with the widely used Apple iPhone series (e.g., 3G, 3GS and 4), iPad, and/or iPod Touch devices. The package allows health care providers to securely access their patients' medical records; transmit prescriptions to pharmacies; review diagnostic test results; view upcoming patient appointments and daily schedules; send, view and receive messages; and other functionality achieved from their mobile device(s), wherever they have a WiFi or cellular connection.

In a representative embodiment, the EMR software package comprises at least two major components, namely (1) a Client Application (“EMR Link”) installed on an associated portable data device (iPhone, iPad, iPod Touch, etc.); and (2) a Server Sided Application, which is installed on the user's network.

In one exemplary embodiment, the Server Sided application interfaces with the EMR, specifically with e-MDs Solution Series. Calls are made to the EMR SQL Server database to read and write information. Additionally, the Server Sided application interfaces with Microsoft Internet Information Services (“IIS”) to provide additional functionality, such as viewing of documents, laboratory test results, patient pictures, etc. The Client Application communicates both with the EMR SQL Server Database via a secure connection, as well as with the IIS server.

In another embodiment, the Client Application is distributed via the Apple App Store, with updates being delivered in that manner. The Server Sided Application is typically distributed via the World Wide Web.

In yet another embodiment, the user can remotely view his or her appointment schedule from his or her mobile device. The schedule can be filtered by date, provider, and/or medical facility. The specific types of details that can be viewed will vary by user preference, but comprise appointment times, patient notes, and/or the length of the appointment. In other example embodiments, the appointment detail view provides the user with a direct link to the patient's chart.

In another example embodiment, the user can open, view and modify or append a supplement to a patient's record. The user can also search their entire EMR database for a specific patient's chart, and view various patient demographics, including, but not limited to, the patient's address (with maps and directions if desired), patient telephone numbers (with the option to directly dial from the mobile device), financial information (including medical insurance data and patient and insurance balances), visit information (including first and last visit dates), and so on. All notes and alerts are likewise entered into the system.

In further embodiments, the user is able to view all of his or her clinical chart notes and log or telephone notes. In one example embodiment, the user also has the ability to create a new note and/or addend a previous note, allowing the user to, among other things, document after-hours conversations with patients. Additionally, the user is able to view documents (including, but not limited to, scanned documents), laboratory test results, and patient paperwork. If desired, the user can electronically “sign off” on any or all such documents.

The user also has the ability to view a patient's medication list, including the medication name, signature, quantity, refill information, and delivery method. In certain embodiments, the user records to the database a new prescription or refill, and submits a new prescription or refill to a facsimile server for automatic transmission to the pharmacy. The user can then view associated patient reminders including diagnostic tests due, patient problem/diagnosis lists, chart notes associated with a specific problem, and patient appointment history.

In still further embodiments, the user is able to view various billing and financial information for a particular provider and/or facility, including monthly and yearly charges, collections, adjustments, and overall accounts receivables, all of which may be filtered by provider and/or facility.

In other example embodiments, the user has full messaging capabilities through integration with the e-MDs TaskMan™ messaging system, or another similar service associated with a different records delivery package. The user is therefore able to send and receive inter-office messages, view attachments to messages with direct links to various documents, including patient charts, patient documents/laboratory test results, and patient chart notes. Optimally, the user can also draft, reply to, and forward incoming and outgoing messages.

In another embodiment, the user is able to track office flow. For example, the user can track patients in the clinic, showing patient flow in the waiting room and examination rooms, and patients that have checked out of the office. The user is able to utilize visual cues as to who is next to be seen, with direct links to each patient's chart.

In still another embodiment, the user is able to utilize the “briefcase” feature, which allows storage of a link to the patient's file on the device for reference at a later time. In a further embodiment, the user has the ability to add a message reminder.

In a still further embodiment, the user has full help functionality. In another example embodiment, the user is able to customize various settings of the application.

In many of the above-described embodiments, the user connects to his or her EMR database through a secure VPN connection. User Name, User ID, and Password are encrypted and required. Access privileges are verified for various features, and the user must have explicit authorization to access and view charts and billing data. In addition, audit trails are written and stored to the database.

In additional embodiments, users can acquire a license to use the EMR software package on either a monthly or yearly basis. Licenses can be purchased in the application via the Apple App Store or by other means that will be appreciated by those of skill in the art. Licenses can be stored on both the user's database and in a “cloud” database, or in a manner consistent with the development of evolving electronic technologies.

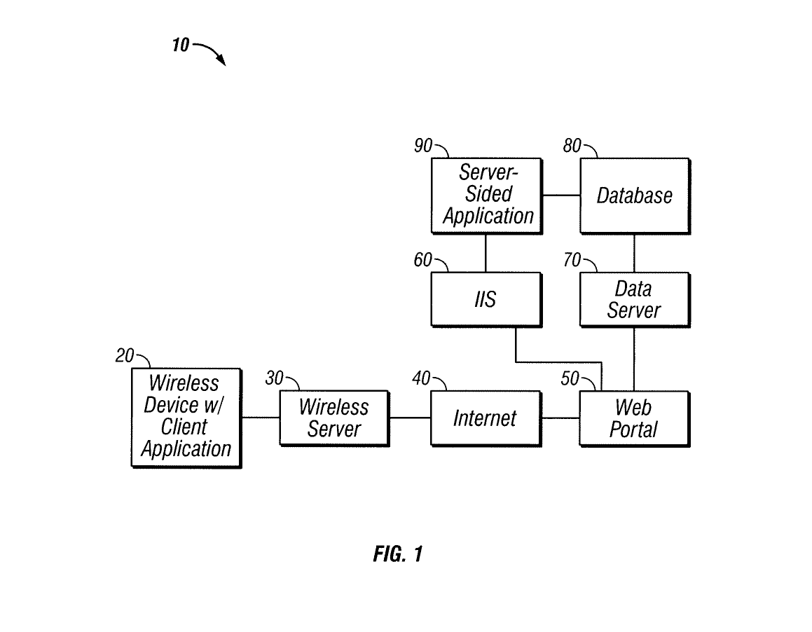

Referring now to the illustrative example depicted in FIG. 1, a system 10 is provided for accessing information wirelessly from an EMR database 80. In some embodiments, the database 80 is linked to a web portal 50 through a data server 70. In other embodiments, the web portal 50 allows a client to access the database 80 over the Internet 40. In further embodiments, the web portal 50 is connected over the Internet 40 to a wireless server 30 associated with a wireless device 20 having a client application installed thereon. In still further embodiments, the client application allows the client to access information critical to the client's patients and other information important to the client.

In still other embodiments, the server-sided application 90 is in operative communication with the EMR database 80, as well as, in certain embodiments, the internet information services server 60.

FIG. 1 is also illustrative of an associated method suitable for using such a system. Despite the specificity shown and described herein, the depicted embodiments are merely representative of the process flow and system structure that will enable the invention, and many other method flow paths and system structures may be interposed or substituted while remaining within the scope of the present disclosure.

The foregoing specification is provided for illustrative purposes only and is not intended to describe all possible aspects of the present invention. Moreover, while the invention has been shown and described in detail with respect to several exemplary embodiments, those of ordinary skill in the art will appreciate that minor changes to the description, and various other modifications, omissions and additions may also be made without departing from the spirit or scope thereof.

1. A system for accessing electronic records comprising:
a client application installed on a mobile data device;
a server-sided application installed on a client network;
a records server database; and
an internet information services server;
wherein the server-sided application is in operative communication with the records server database and the internet information services server; and
the client application is in operative communication with the records server database and the internet information services server using a secure connection.

2. The system of claim 1, wherein the secure connection is a virtual private network.

3. A method of accessing information stored on a records server database, comprising:
receiving a request for information from a server-sided application;
transmitting said information from the records server database to the server-sided application;
converting said information into data readable on a mobile data device; and
transmitting said data to said mobile device using a client-sided application.

4. The method of claim 3, wherein the transmitting step occurs over a virtual private network.
